(19) United States
(12) Patent Application Publication
(10) Pub. No.: US 2003/0015537 A1
(43) Pub. Date: Jan. 23, 2003

(54) Vehicle fuel tank with fuel wave baffle

(76) Inventor: Namir A. Konja, Farmington Hills, MI (US)

Correspondence Address: DAIMLERCHRYSLER INTELLECTUAL CAPITAL CORPORATION, CIMS 483-02-19, 800 CHRYSLER DR EAST, AUBURN HILLS, MI, 48326-2757, US

(21) Appl. No.: 09/909,432

(22) Filed: Jul. 19, 2001

(51) Int. Cl. B60P 3/00; B62D 33/00; B65D 88/12

(52) U.S. Cl. 220/563; 137/574

(57) ABSTRACT

A baffle unit for operative cross mounting within a liquid fuel tank of an automotive vehicle to attenuate wave action of the liquid fuel within the tank during vehicle operation and thereby prevent or reduce the impact of such fluid motion against the wall of the tank and thereby eliminate or reduce harshness, vibration and noise. The baffle unit comprises a frame with latticed work defining open side faces encapsulating a mat of fiberglass filaments caged therein and having a porosity for the passage of waves of liquid fuel therethrough to attenuate the waves while trapping particles of fuel-contaminating foreign matter The frame is supported for telescoping action in a carrier. Helical end springs urge the frame to an outer position against the interior walls of the tank after the unit is compressed to collapse the unit to allow its easy insertion into the tank. The baffle unit can readily be used as an additional fluid filter by the hydraulic connection of the interior of the frame member with the intake of the fluid pump operatively mounted within the tank.

This invention relates in general to fuel wave baffling fuel tanks supplying liquid fuel to internal combustion engines powering vehicles and more particularly to new and improved fuel wave baffle construction for wave attenuation and resultant noise, vibration and harshness abatement in vehicles when operatively mounted within their fuel tanks and further to such baffles capable of fuel filtering prior to being pumped from the tank.

Prior to the present invention, liquid fuel tanks for automotive vehicles have been designed with various constructions to reduce noise, vibration and ride harshness, frequently referenced as NVH, generated by the motion of fuel impacting the walls of the tank during vehicle operation. For example many vehicles have fuel tanks molded from plastics and have fixed baffles directly molded therein. Other tanks have been designed with discrete internal wave baffles and others with special filter units to filter engine fuel prior to such fuel being pumped from the tank for combustion by an internal combustion engine powering the vehicle. Examples of such constructions can be found in the U.S. Pat. No. 5,850,933 issued Dec. 22, 1988 to Pazik for Molded Gas Tank With Internal Baffle; U.S. Pat. No. 6,138,859 issued Oct. 31, 2000 to Aulph et al for Fuel Tank Assembly; U.S. Pat. No. 4,974,743 issued Dec. 5, 1990 to Sasaki for Fuel Tank With Noise Suppressing Arrangement and U.S. Pat. No. 6,098,599 issued Aug. 8, 2000 to Muldoon et al for System for Delivering Fuel to A Motor Vehicle and Related Method

While the prior constructions generally attain their objectives, they do not meet new and higher standards for optimal liquid fuel motion damping and attendant control of fuel wave generated noises, vibration and harshness transmitted into the vehicle. Moreover, they are not capable of providing additional new and improved filtration of fuel to improve operation of fuel pump units supplying the engine with fuel from the tank.

In contrast to the prior art constructions, the present invention effectively reduces or eliminates such noise, vibration and harshness problems and meets higher standards to efficiently moderate fuel motion within the tank to reduce or eliminate consequential NVH problems. Optimized vibration, noise and vibration reduction is accomplished in the present invention with a new and improved wave damping baffle unit which can be readily fabricated from light weight and durable materials and components that incorporates fuel media permeable and wave damping media which can be readily installed in a fuel tank and have long service life. Moreover, this wave-damping unit can be further and advantageously utilized to provide superior filtering of foreign matter from the liquid fuel contained within the fluid tank to eliminate contaminant damage to components of the fuel delivery system.

An object, feature and advantage of the present invention is to provide a new and improved fuel wave baffle construction that can be readily produced and easily and straightforwardly introduced into a fuel tank of an automotive vehicle and subsequently located therein at a predetermined and permanent position.

Further it is an object of this invention to provide a new and improved combination fuel wave baffle and filter unit operatively mounted in a liquid fuel tank of an automotive vehicle having internal flow controlling medium providing optimized abatement of fuel motions such as waves of fuel occurring during vehicle operation in addition to improved filtering of the liquid fuel prior to being pumped to the internal combustion engine of the vehicle.

Another object feature and advantage of the present invention is to provide a new and improved liquid fuel wave abating baffle unit having flow controlling media of a porosity imparting improved control of fuel flow therethrough and improved management of fluid motion such as fuel wave or “splash” action of liquid fuel within a tank during vehicle operations.

An additional object, feature and advantage of the present invention is to employ the fuel wave controlling media of fuel wave baffle unit in a liquid fuel tank for an automotive vehicle for improved fuel filtering to prevent foreign matter from being delivered to the fuel pump and other components such as pressure regulating valves and fuel injectors operatively associated with the combustion chambers of the vehicle engine.

The baffle and filter unit of one preferred embodiment of the invention operates in parallel with the conventional fuel pump or fuel sender unit filter. The filtering media of the baffle and filter unit preferably has fine filtration capability designed for optimizing the separation of foreign matter from the fuel to thereby extend the life cycle of the fuel pump as well as the fuel pressure regulator and other fuel delivery components susceptible of being contaminated by such foreign matter. The media used in the baffle and filter construction preferably comprises a non-woven mat of 3-5 micron diameter filaments of fiberglass to abate the waves of fuel passing therethrough and to provide a substantial increase in overall surface area and dirt capacity (life time) of filtration and supplementing existing internal filters while reducing the need for external filtration systems.

The baffle and the baffle and filter units may be conveniently installed through the fuel pump module opening provided in the tank. This can be readily accomplished since the units employ a pair of basic retainer components that are spring loaded and can be selectively and telescopically compressed together to reduce the dimensions thereof. This size reduction allows the unit to be easily inserted through the opening in the fuel tank. After initial insertion and subsequent positioning in the tank, the components of the unit are released so that they automatically expand under spring loading for secure spring biased retention of the unit within the fuel tank at a predetermined home position.

These and other objects advantages and features of the present invention will become more apparent from the following detailed description and drawing in which:

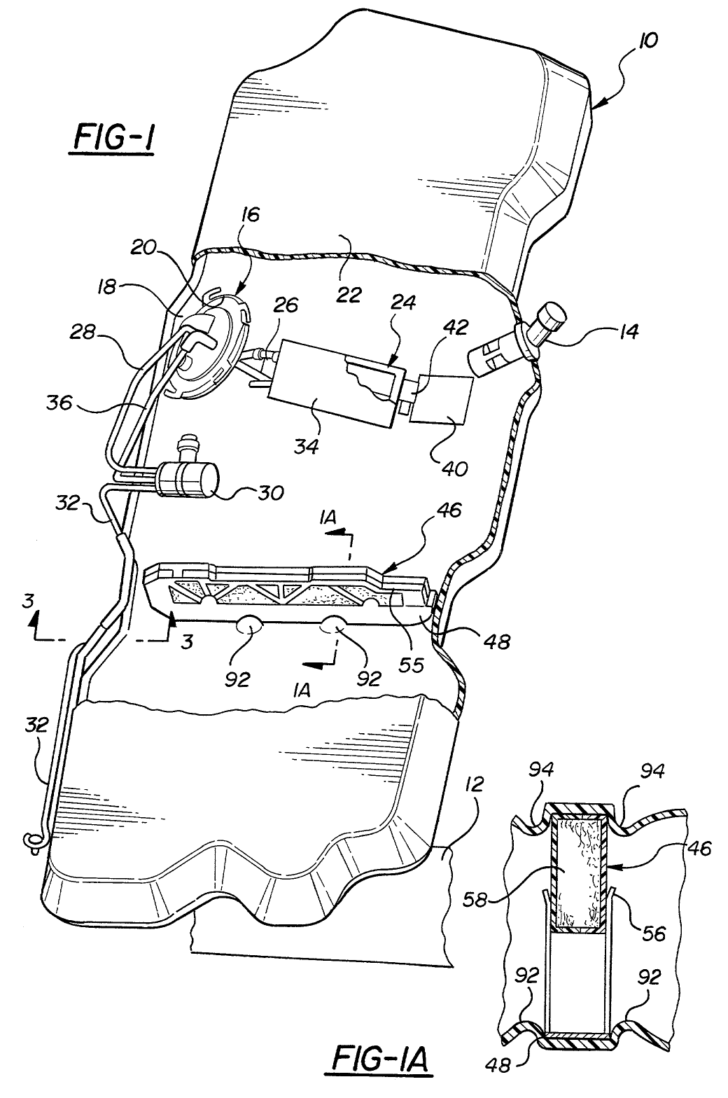

FIG. 1 is a pictorial view of a liquid fuel tank for an automotive vehicle with an upper wall portion thereof partially broken away;

FIG. 1a is a partial sectional view taken generally along sight lines 1a-1a of FIG. 1;

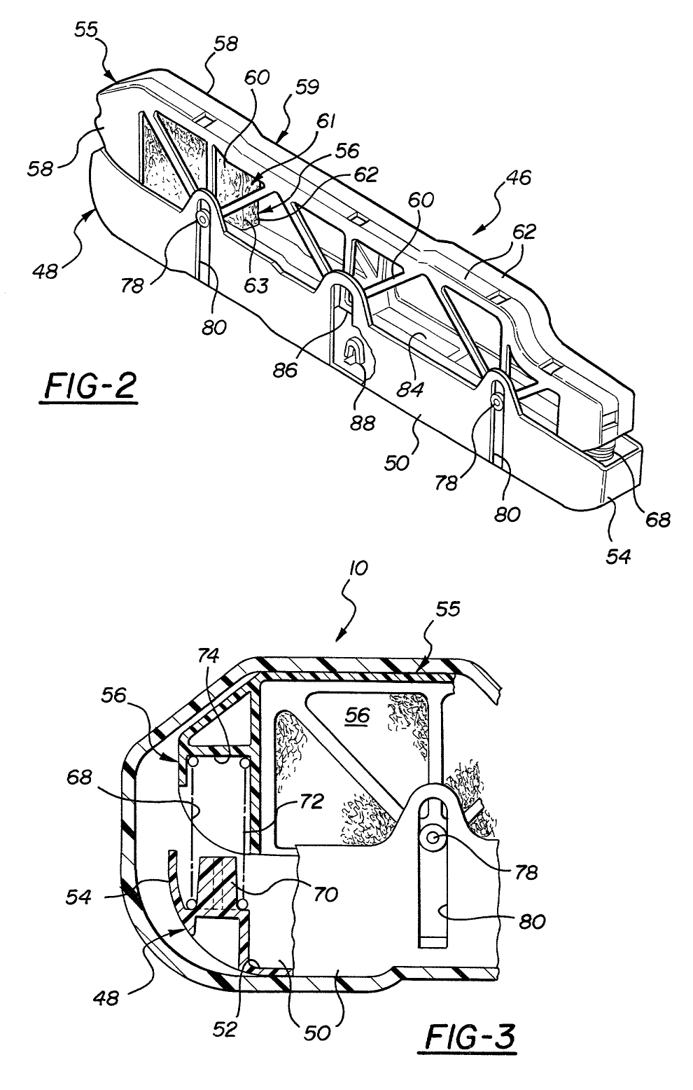

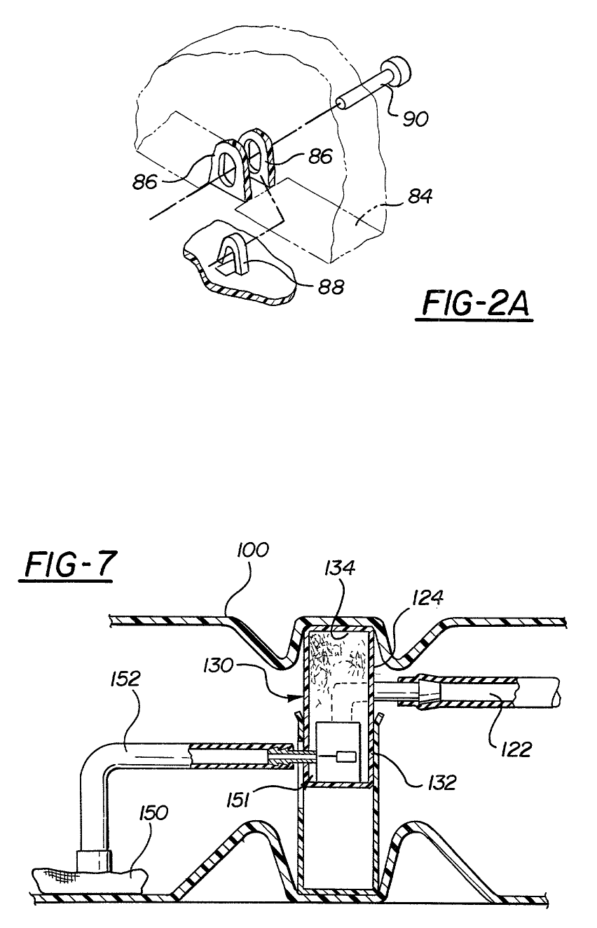

FIG. 2 is a pictorial view of the baffle unit utilized in the fuel tank of FIG. 1 with baffle media partially cut away;

FIG. 2a is a pictorial view of a portion of the baffle unit of FIG. 2

FIG. 3 is an enlarged cross sectional view of a portion of the baffle unit of FIG. 2 as installed in the fuel tank and taken generally along sight lines 3-3 of FIG. 1;

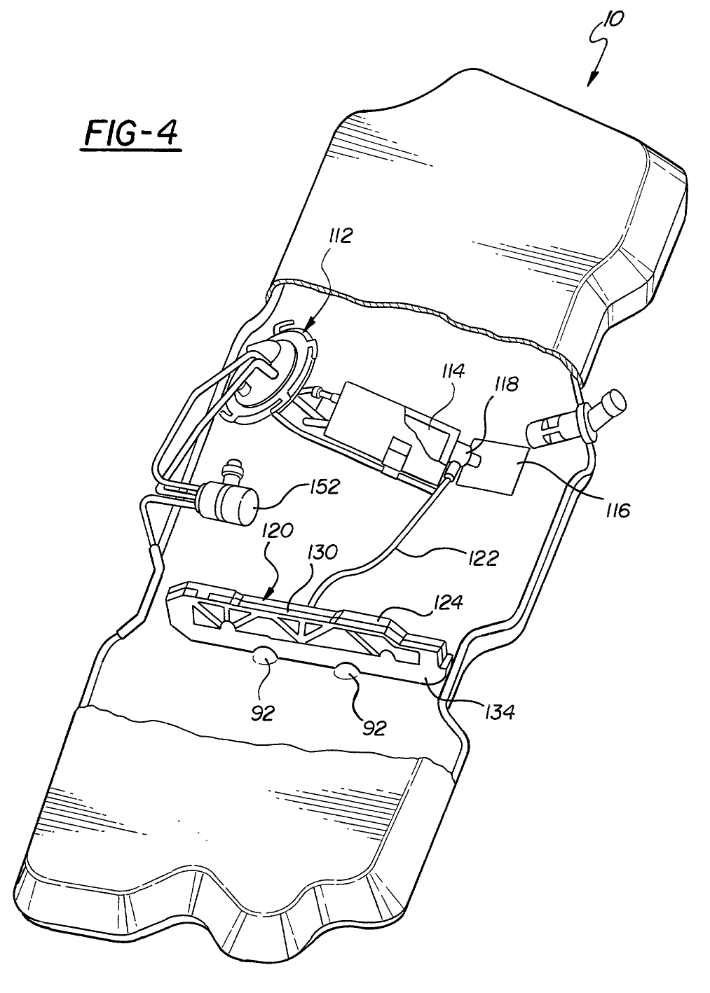

FIG. 4 is a pictorial view similar to the pictorial view of FIG. 1 illustrating an embodiment of the inventor;

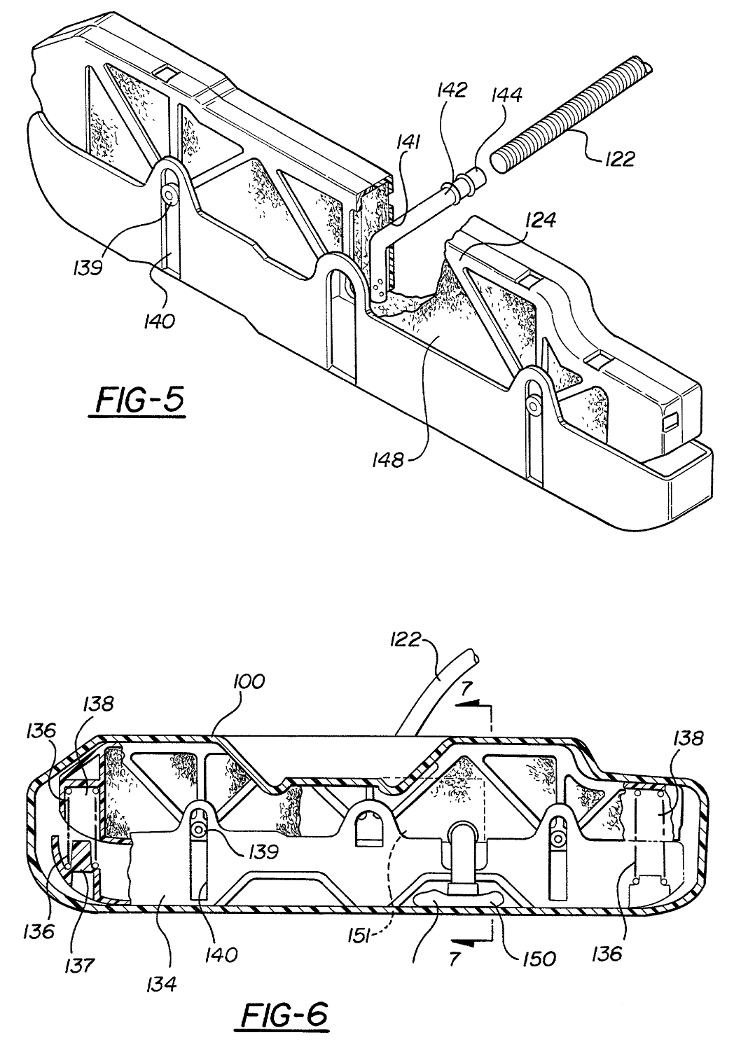

FIG. 5 is a pictorial view of the baffle unit of FIG. 4 partially broken away to illustrate interior details thereof;

FIG. 6 is a sectional view of the baffle unit of FIG. 5 installed in the fuel tank of FIGS. 1 and 4 and further modified to illustrate another embodiment of the invention.

FIG. 7 is a sectional view taken generally along sight lines 7-7 of FIG. 6;

### DETAILED DESCRIPTION

Turning now in detail to the drawings there is shown in FIG. 1 a shell-like liquid fuel tank 10 strapped or otherwise mounted on a support 12 of an automotive vehicle powered by an internal combustion engine, not shown. The tank 10, preferably blow molded from a suitable plastic material, has a fuel inlet filler tube 14 and provides a container for the effective storage and on-board transport of liquid fuel such as gasoline for delivery to and combustion by the vehicle engine. More particularly, the fuel is supplied to the engine by means of a fuel sender or fuel pump module 16 that is operatively supported in the tank for operation by a removable cover 18 closing an access opening 20 formed in the upper wall 22 of the tank.

The fuel pump module 16 is a conventional unit and includes an internal fuel pump 24 operatively connected to an adjacent pressure regulator 26 that operatively regulates the pressure of the fuel discharged by the pump 24. This discharged fuel is fed through line 28 external filter 30 and then through line 32 to the combustion chamber charging mechanisms, not illustrated. Excess fuel from the fuel pressure regulator is filtered by filter 30 and then fed back into an internal reservoir 34 through line 36 for subsequent delivery to the engine as is known in the art.

The fuel pump module 16 further incorporates a primary fuel filter 40 operatively connected to an intake 42 of the pump and strategically located placed at a low point in the tank so that fuel can be effectively drawn from the tank through the minute straining voids of the filtering media of the filter. This filter effectively catches and traps foreign matter downstream of the pump and prevents foreign matter from entering the pump, pressure regulator as well as other components that receive fuel from the pump.

To dampen the wave action or “sloshing” or other motion of the liquid fuel in the tank and against the wall thereof, the present invention provides a new and improved fuel wave baffle unit or assembly 46. The baffle assembly is a discrete, separately built unit, which is readily adaptable to various tank constructions, and particularly those formed of plastics such as by blow molding. The baffle assembly is shown in better detail in FIGS. 2 and 3 and comprises an elongated, shell-like carrier 48. The carrier is molded from Acetal or other suitable plastic material and has laterally spaced sidewalls 50 extending upwardly from a flattened bottom wall 52 and closed at opposite ends by end walls 54.

The carrier 48 is further defined by an opened upper side to provide a cradle or receiver for a cage-like frame member 55 containing a fibrous fuel flow control media 56. The frame member 55, molded from polyethylene or other suitable plastics, is operatively mounted in the carrier for telescopic movement between fully compressed or fully extended positions. More particularly the frame member 55 comprises of a pair of elongated side frame members 58 of Acetal each having lattice work defining a flattened side face 60 with open fluid-flow windows. The side frame members have peripheral edge walls 62. These edge walls align and project toward one another for contact and permanent connection at their interfacing terminal edge surfaces. The side frame members 58 when joined provide a surrounding retainer for the fuel porous media 56 completely filling the retainer and define a media unit 59 operative to attenuate the waves of fuel as the fuel flows therethrough on wave movement from one end of the tank toward the other. The media unit may be made in any suitable shape and from any suitable materials such as a pillow-like mat of non-woven fiberglass filaments or fibers covered by a scrim 63 of polyester or other suitable material.

FIGS. 2 and 3 best illustrate the telescopic features of the baffle assembly 46 and show the media unit 59 operatively seated within the shell-like carrier 48 and extending upwardly from the open top end thereof. A pair of helical biasing springs 68, only one of which is shown in FIG. 3, are operatively disposed between the carrier and the filter unit at opposite ends of the unit and near the end walls 54 of the carrier. These springs provide the force to urge the two components of the baffle assembly from one another and into an expanded position and into close-fitting engagement with the inner surfaces of the upper and lower wall portions of the fuel tank 10. This construction and fit is best shown in FIG. 3 in which helical spring 68 is seated on a retainer post 70 projecting upwardly from the bottom wall 52 of carrier 48. The upper end of the spring 68 is received in the downwardly extending spring pocket 72 formed in the ends of the filter assembly and seats on the upper pocket closure wall 74 thereof.

To maintain the baffle assembly 46 operatively together so that the components can be telescoped between opened and closed position without coming apart, both sides of the of the filter assembly are provided with outwardly projecting followers 78 which are adapted to ride in guide and retainer slots 80 that extend vertically in the side walls 50 of the carrier 48. The contact of these followers with the upper extent of their associated slots provides the telescopic outer travel limit of the components of the baffle assembly.

The bottom wall 84 formed by the lower edge walls of the frame member 55 of the media unit 59 has a pair of laterally-spaced retainer ears 86 projecting therefrom. These ears are designed to receive a fixed retainer ear 88 extending upwardly from the bottom wall of the carrier and all of these elements are suitably holed so that when aligned can receive a retainer pin 90 therethrough. This pin releasably keeps the media unit 59 and carrier 48 in a telescopically contracted condition.

With this construction, the components of the baffle assembly 46 can be collapsed to a full telescoped position and then retained in this condition by use of the retainer pin 90. The collapsed baffle assembly, retained in a telescoped state and reduced in size, can be manually or otherwise inserted through the enlarged circular access opening 20 in the top of the tank and positioned therein between the pairs of spaced locator and retainer bumps 92 and 94 formed in the top and bottom wall portion of the tank. The telescoped assembly can then be released by removing pin 90 such as with the use of suitable tooling and allowed to expand under spring loading so that it is trapped in a stabilized and predetermined position within the tank between the bumps as diagrammatically illustrated in FIG. 1a.

Baffle operation most effectively takes place when the tank has larger volumes of liquid fuel therein and when waves of liquid fuel are generated as the vehicle is driven. Such waves may travel from one end of the tank 10 toward the other and fronting the baffle assembly. These waves will be effectively modulated or eliminated as the liquid fuel passes thorough the cross-tank barrier provided by the baffle unit and particularly through the media carried by the baffle so that the walls of the tank are not excessively impacted by moving waves of fuel. Such fluid motion control accordingly reduces or effectively eliminates fuel wave induced vehicle ride harshness, vibration and noise to optimize vehicle operation and passenger comfort.

The baffle assembly can further be effectively utilized to augment the filtering of fuel provided by the fuel filter 40. In FIG. 4 for example, the fuel tank 100 has a fuel sender or pump module 112 including internal liquid fuel pump 114 operative to draw fuel from a low point in the center of the tank through filter 116 via the interconnecting pump intake 118 as in the FIG. 1 construction. To provide additional fuel filtering capacity a fuel wave attenuating or baffle assembly substantially the same as the assembly 46 of FIGS. 1-3 can be utilized.

More particularly a combination fuel wave baffle and fluid filter assembly 120 extending across the fuel tank as in the FIG. 1 construction is utilized. The baffle and filter assembly 120 and fuel pump intake 118 are slightly modified as compared to the FIG. 1 construction with appropriate fluid connections added for coupling to a flexible fuel conducting hose 122 extending therebetween. This construction is advantageously employed to hydraulically connect the interior of the baffle and filter assembly 120 with the fuel pump intake 118 of the fuel pump so that additional fuel may be filtered and transmitted into the pump and then pumped into the fuel delivery components downstream of the pump.

The wave baffle and fluid filter assembly 120 comprises open-faced and cage-like retainer or frame member 124 that encapsulates media 126 which preferably is the same as the media 56 of FIGS. 1-3 above. The frame and its captured media define the media unit 130 that not only damps fluid wave action but also further operates to filter foreign matter from the liquid fuel prior to delivery to the pump. The media 126 comprises a mat 132 of 3-5 micron diameter fiberglass filaments encased by a scrim 134 or other suitable covering.

The retainer or frame member 124 is basically the same as the retainer of FIGS. 1-3 in so far as material and general construction are concerned and has opposing open sides. These sides are defined by the lattice work of intersecting strips of polyethylene providing opposing side windows allowing the fuel to flow through the media while damping the wave action of the fuel to minimize impact of the waves on the wall of the fuel tank. The strips defining these windows can be hermetically or otherwise sealed to the scrim to ensure that the fuel does not go around or bypass the media in the frame thereby compromising or otherwise detracting from the damping characteristics or fuel filtering capability of the media. The media further operates as a wick or sponge, retains fuel in the minute voids thereof, and therefore holds fuel within the confines of the frame member 124.

The media unit 130 is preferably an upper member of the baffle and filter assembly 120 and is operatively mounted for telescopic movement with respect to a lower carrier 134. As in the FIG. 1 construction the lower carrier is configured as an elongated shell with an open top that telescopically receives the media unit 130. A pair of helical springs 136 mounted on retainers 137 formed on the lower wall of the carrier extending upwardly into endmost spring pockets 138 in the frame of the media unit and seat on the closure wall thereof as best shown in FIG. 6.

The two spring biased telescoping components i.e. the media unit 130 and carrier 134 are operatively maintained in their sliding telescopic relationship by followers 139 extending from the sides of the media unit which ride in the vertical slots 140 formed in the sides of the carrier.

The open-faced frame member 124 of the media unit is further modified to have an opening 141 in outboard side thereof that receives a fluid conducting and connector tube 142. This connector tube is securely fixed to a solid portion of the side wall provided by one of the outboard plastic strips of the frame member and is designed to extend from the interior of the media to an external head portion 144 and thereby into fluid tight connection with the flexible hose 122 that operatively connects into the pump intake with a quick connect fitting. With this construction the media unit operatively connects into the pump intake 118 so that the pump 114 can be further supplied with additional filtered fuel to thereby reduce fuel starvation by the pump. The connector tube 142 configuration shown in FIG. 5 has an inner most end that may be perforated and terminates within the media and within a fuel containment portion 148 provided by the tray-like bottom of the frame member 124 to augment fuel availability when the tank has a low level of fuel. This construction can be replaced by a straight tube or other suitable configuration.

FIGS. 6 and 7 illustrate the employment of a third fuel filter 150 outside of the baffle unit and seated at a low point in the tank 100 may be provided to wick up fuel therefrom. This latter filter hydraulically connects to a suitable valve unit 151 mounted in the interior of the media unit 130 of the wave baffle and filter by fuel conducting tube 152. The valve unit is normally open and is operative to allow filtered fluid to enter from the media which is then fed into the nose 122 connected into the pump. However, when the fuel in the tank becomes very low, the valve closes with respect to the baffle unit such as by operation of a float and fuel is then supplied to the nose only through the filter 150.

With this construction, the fuel wave attenuation baffle can be effectively utilized to filter foreign matter from the fuel prior to the fuel being pumped to the fuel delivery system components down stream of the pump. This importantly adds additional in-tank filtering capacity and insures that the pump is adequately supplied with fuel even when the fuel quality has been compromised by particulate of foreign matter. Moreover, with this invention the external filter 152 in the delivery line lead from the tank may potentially be eliminated. Furthermore, the units of FIGS. 4-7 may be telescoped and maintained in closed position by the closure pin construction which is like the pin and retainer construction of FIG. 2a and then easily installed through the opening in the top of the tank in a manner similar to the method disclosed in connection with FIGS. 1-3 with attention being duly paid to the hose hook up between the baffle and filter unit and the pump intake. A conventional snap in or other type quick connect may be used to connect the hose 122 to the pump intake to augment assembly of the wave baffle and filter to the pump.

The invention may be varied in many obvious ways to those skilled in the art and such variations are within the scope and spirit of the following claims:

What is claimed is:

1. A baffle for the attenuation of the motion of liquid fuel in a fuel tank having a shell-like outer wall for an automotive vehicle powered by an internal combustion engine comprising an elongated carrier sized to substantially extend across the expanse of the interior of said tank, a retaining frame dimensioned to telescopically fit said carrier, slide construction for mounting said retaining frame for telescoping movement with respect to said carrier and at least one spring operatively mounted between said carrier and said retaining frame for urging said retaining frame to an outer telescoped position with respect to said carrier so that said baffle can be mounted and retained in a spring biased position in said tank and between upper and lower wall surfaces of said tank, and a fluid damping medium operatively mounted in said retaining frame for attenuating the motions of said fuel in said tank to thereby reduce vibration and noise resulting from the impact of fuel on said walls of said tank.

2. The baffle of claim 1 and wherein said medium is a mat of filaments and wherein said mat is covered with scrim to maintain said mat in a predetermined configuration that substantially fills the interior of said retaining frame.

3. The baffle of claim 1 wherein said carrier is a channeled member that telescopically receives said frame therein and wherein a pair of springs are mounted in said carrier and extend upwardly therefrom into contact with the bottom surface of said frame and wherein opposing outer surface portions of said carrier and said frame engage opposing inner wall surface of said tank under the load of said spring to retain said baffle in said tank.

4. The baffle of claim 3 wherein said opposing wall surfaces of said tank have opposing and laterally spaced locator and retainer bumps formed therein to define a predetermined location to receive said baffle and thereby retain said baffle in a predetermined location within said tank.

5. In combination a liquid fuel tank in an automotive vehicle powered by an internal combustion engine, said tank having a liquid fuel pump therein with a fuel intake and an output to supply fuel to the internal combustion engine, a baffle operatively mounted in said tank to attenuate waves of fuel occurring in said tank and to filter foreign matter from the fuel while in said tank, said baffle comprising an elongated carrier member and a frame member filled with a filtering media operatively supported with respect to said carrier, said baffle being sized to extend across and partition said tank into a plurality of sections, said baffle being operative to abate the waves of fuel in said tank passing therethrough and from one of said sections to the other to lessen the impact of said waves against the wall of the tank, said baffle being further operative to filter foreign matter from the fuel fed therethrough, and a fluid feed line operatively connecting the interior of said frame member and the filtering media therein with the fuel intake so that said pump is fed with filtered fuel prior to being pumped from the tank.

6. A fuel filter and baffle for filtering foreign matter from liquid fuel contained within a fuel tank of an automotive vehicle powered by an internal combustion engine and for the attenuation of waves of fuel acting on the wall defining the fuel tank, said filter and baffle comprising a pad of fuel filtering material having a porosity sufficient to filter contaminating foreign matter from the liquid fuel and to allow the flow of fuel therethrough, a frame for encapsulating said pad and having opposing and open sides to expose said pad to the liquid fuel in said tank to allow the fuel to flow therethrough from one said of the frame to the other.
The fuel filter and baffle of claim 6 and further incorporating a carrier for said media unit, and at least one spring for urging said media unit outwardly from said receiving carrier.

7. The fuel filter and baffle of claim 6 and further including a filter unit mounted adjacent to fuel filter and baffle and operative to filter fuel being fed into said fuel filter and baffle.
